(19) United States
(12) Patent Application Publication
(10) Pub. No.: US 2021/0250724 A1
(43) Pub. Date: Aug. 12, 2021

(54) OPTIMIZED PRESENCE REPORTING AREA INDICATION

(71) Applicant: Telefonaktiebolaget LM Ericsson (publ), Stockholm (SE)

(72) Inventor: Loudon Lee Campbell, Plano, TX (US)

(21) Appl. No.: 16/973,143

(22) PCT Filed: Jun. 6, 2019
(86) PCT No.: PCT/IB2019/054745

§ 371 Date: Dec. 8, 2020

Related U.S. Application Data
(60) Provisional application No. 62/682,643, filed on Jun. 8, 2018.

(51) Int. Cl. H04W 4/021; H04W 4/24

(52) U.S. Cl. CPC H04W 4/021; H04W 4/24

(57) ABSTRACT

Systems and methods for an optimized Presence Reporting Area (PRA) indication are provided. In some embodiments, a method performed by a first entity for reducing signaling for PRA state indication includes determining whether a wireless device is presumed to be in a PRA; and indicating to a second entity whether the wireless device is presumed to be in the PRA. Some embodiments disclosed herein will eliminate extra signaling introduced by a PRA.

### RELATED APPLICATIONS

This application claims the benefit of provisional patent application Ser. No. 62/682,643, filed Jun. 8, 2018, the disclosure of which is hereby incorporated herein by reference in its entirety.

### TECHNICAL FIELD

The disclosure relates to a Presence Reporting Area (PRA) in a cellular communications network.

### BACKGROUND

A Presence Reporting Area (PRA) in Long Term Evolution (LTE) (and New Radio (NR)) is used in policy and billing to create policy and billing rates based on User Equipment (UE) location. For example:
a) A single PRA might be defined to represent any National Football League stadium in the United States. Billing and policy inside the football stadiums may be different (especially for streaming of video of football games).
b) A single PRA might be defined to represent a very large chain of stores (IKEA, Walmart, etc.). Third party billing to the store chain (IKEA, Walmart, etc.) only applies in the store locations, not outside it.
c) Local service plans. i.e., higher billing rates outside a local region of a user (so called extended region).

Physically in most of the above examples, the typical UE in real life rarely crosses a PRA border, but it is necessary to know when it occurs. However, when PRA is activated, there is extra signaling in the core network today simply to indicate the UE's initial PRA. This may cause extra signaling. As such, improved systems and methods for PRA reporting are needed.

### SUMMARY

Systems and methods for optimized Presence Reporting Area (PRA) indication are provided. In some embodiments, a method performed by a first entity for reducing signaling for a Presence Reporting Area (PRA) state indication includes determining whether a wireless device is presumed to be in a PRA; and indicating to a second entity whether the wireless device is presumed to be in the PRA. Some embodiments disclosed herein will eliminate extra signaling introduced by a PRA.

In some embodiments, the first entity is a charging entity such as a Policy and Charging Rules Function (PCRF) or a Policy Control Function (PCF). In some embodiments, the second entity is a Packet Gateway (PGW), a Session Management Function (SMF), or a combined SMF and control plane PGW (PGW-C).

In some embodiments, determining whether the wireless device is presumed to be in the PRA comprises determining that the wireless device is presumed to be in the PRA if the wireless device is more likely to be in the PRA. In some embodiments, determining whether the wireless device is presumed to be in the PRA comprises determining whether the wireless device is presumed to be in the PRA based on a size of the PRA.

In some embodiments, the first entity is a PGW, the second entity is a Serving Gateway (SGW), and indicating to the second entity whether the wireless device is presumed to be in the PRA comprises sending a Create Session Response to the SGW indicating whether the wireless device is presumed to be in the PRA.

In some embodiments, the second entity is a Session Management Function (SMF) or a combined SMF and control plane PGW (PGW-C) and the method also includes the second entity providing to an Authentication Management Function (AMF) an indication whether the wireless device is presumed to be in the PRA.

In some embodiments, the first entity is a SGW, the second entity is a mobility entity such as a Mobility Management Entity (MME), and indicating to the second entity whether the wireless device is presumed to be in the PRA comprises sending a Create Session Response to the mobility entity indicating whether the wireless device is presumed to be in the PRA.

In some embodiments, indicating to the second entity whether the wireless device is presumed to be in the PRA comprises sending a PRA Action to the second entity that indicates whether the wireless device is presumed to be in the PRA. In some embodiments, two bits in octet five of the PRA Action indicate whether the wireless device is presumed to be in the PRA. In some embodiments, a value of zero for the two bits indicates no presumption; a value of one for the two bits indicates the wireless device is presumed to be in the PRA; and a value of two for the two bits indicates the wireless device is presumed to be out of the PRA.

In some embodiments, the first entity operates in a Long Term Evolution (LTE) network. In some embodiments, the first entity operates in a Fifth Generation (5G) and/or New Radio (NR) network.

In some embodiments, the first entity for reducing signaling for PRA state indication includes at least one processor and memory. The memory includes instructions executable by the at least one processor whereby the first entity is operable to: determine whether a wireless device is presumed to be in a PRA; and indicate to a second entity whether the wireless device is presumed to be in the PRA.

In some embodiments, a first entity for reducing signaling for PRA state indication includes a determination module operable to determine whether a wireless device is presumed to be in a PRA; and an indication module operable to indicate to a second entity whether the wireless device is presumed to be in the PRA.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates one example of a cellular communications network according to some embodiments of the present disclosure;

FIG. 2 illustrates the operation of a first entity determining whether a wireless device is presumed to be in a Presence Reporting Area (PRA), according to some embodiments of the present disclosure;

FIG. 3 illustrates a previous procedure for standalone Packet Data Network (PDN) activation where extra signaling is added when PRA is enabled, according to some embodiments of the present disclosure;

FIG. 4 illustrates an embodiment where the wireless device is initially presumed to be in the PRA, according to some embodiments of the present disclosure;

FIG. 5A illustrates an example that includes additional signaling where a Policy and Charging Rules Function (PCRF) can enable a PRA well after a PDN activation, according to some embodiments of the present disclosure;

FIG. 5B illustrates a procedure similar to FIG. 5A in a New Radio (NR) context, according to some embodiments of the present disclosure;

FIG. 6A illustrates the same procedure as FIG. 5A, but with the assumption that the wireless device is in the PRA, according to some embodiments of the present disclosure;

FIG. 6B illustrates the same procedure as FIG. 5B, but with the assumption that the PRA state is the same as the “presumed” PRA state, according to some embodiments of the present disclosure;

FIG. 7 illustrates a wireless communication system represented as a 5G network architecture composed of core Network Functions (NFs), according to some embodiments of the present disclosure;

FIG. 8 illustrates a 5G network architecture using service-based interfaces between the NFs in the control plane, instead of the point-to-point reference points/interfaces used in the 5G network architecture of FIG. 7, according to some embodiments of the present disclosure;

FIG. 9 is a schematic block diagram of a radio access node, according to some embodiments of the present disclosure;

FIG. 10 is a schematic block diagram that illustrates a virtualized embodiment of the radio access node, according to some embodiments of the present disclosure;

FIG. 11 is a schematic block diagram of the radio access node, according to some embodiments of the present disclosure;

FIG. 12 is a schematic block diagram of a User Equipment device (UE), according to some embodiments of the present disclosure;

FIG. 13 is a schematic block diagram of the UE according to some other embodiments of the present disclosure;

FIG. 14 illustrates a communication system that includes a telecommunication network, such as a 3GPP-type cellular network, which comprises an access network, such as a RAN, and a core network, according to some embodiments of the present disclosure;

FIG. 15 illustrates additional details regarding the host computer, base station, and UE in the communication system of FIG. 14, according to some embodiments of the present disclosure; and

FIGS. 16 through 19 are flowcharts illustrating methods implemented in a communication system, according to some embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless device.

Radio Access Node: As used herein, a “radio access node” or “radio network node” is any node in a radio access network of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), and a relay node.

Core Network Node: As used herein, a “core network node” is any type of node in a core network. Some examples of a core network node include, e.g., a Mobility Management Entity (MME), a Packet Data Network Gateway (PGW), a Service Capability Exposure Function (SCEF), or the like.

Wireless Device: As used herein, a “wireless device” is any type of device that has access to (i.e., is served by) a cellular communications network by wirelessly transmitting and/or receiving signals to a radio access node(s). Some examples of a wireless device include, but are not limited to, a User Equipment device (UE) in a 3GPP network and a Machine Type Communication (MTC) device.

Network Node: As used herein, a “network node” is any node that is either part of the radio access network or the core network of a cellular communications network/system.

A Presence Reporting Area (PRA) in LTE (and NR) is used in policy and billing to create policy and billing rates based on UE location. Physically, the typical UE in real life rarely crosses a PRA border, but it is necessary to know when it occurs. However, when PRA is activated, there is extra signaling in the core network today simply to indicate the UE's initial PRA. This may cause extra signaling. As such, improved systems and methods for PRA reporting are needed.

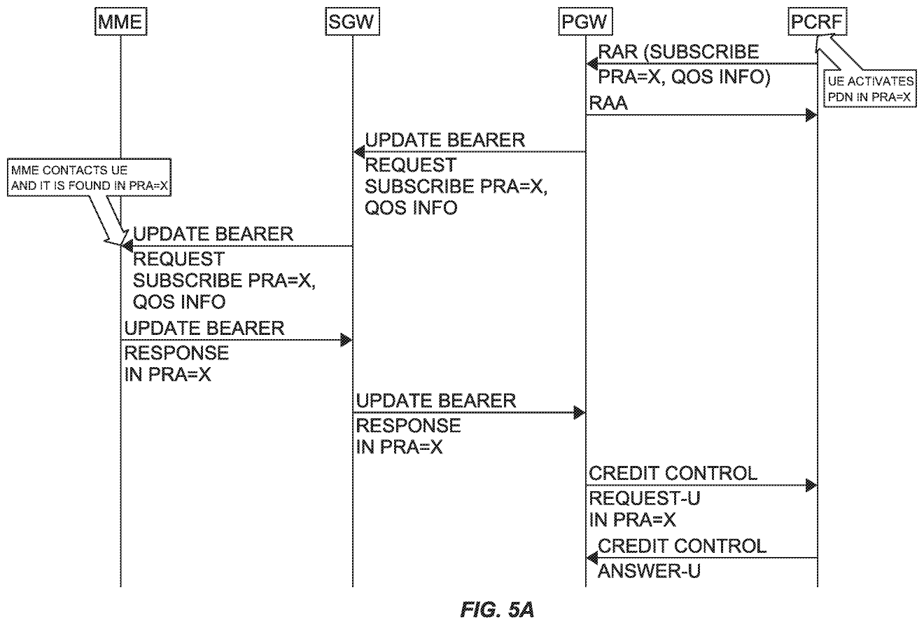

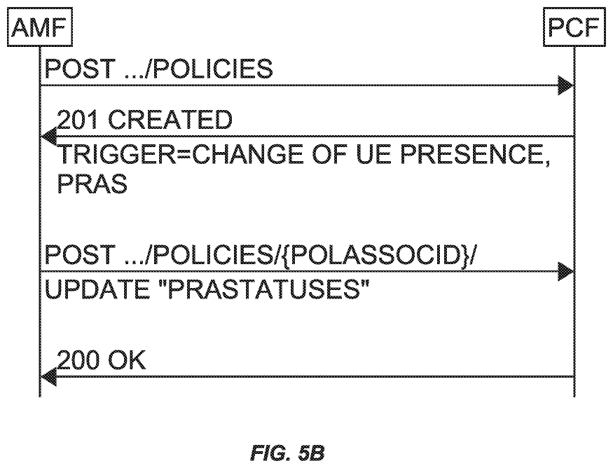

To illustrate the extra signaling that PRA adds when enabled today, the best illustration is in the standalone Packet Data Network (PDN) activation. That activation normally has no Gx or Gy signaling after the Create Session Response. For more information, see Technical Specification (TS) 23.401 “General Packet Radio Service (GPRS) enhancements for Evolved Universal Terrestrial Radio Access Network (E-UTRAN) access” FIG. 5.10.21: UE requested PDN connectivity. However, with PRA enabled at PDN activation, there is extra Gx signaling (see text of step 13a and following Note 8 in chapter 5.10.2 (the PDN GW forwards the PRA Information to the Policy and Charging Rules Function (PCRF), to the Online Charging System (OCS) or to both as defined in TS 23.203)).

Note that the PDN Gateway (GW) forwards the PRA Information to the PCRF, to the OCS, or to both as defined in 3GPP TS 23.203: “Policy and Charging Control Architecture.”

When activated at attach/PDN procedures, there is currently extra signaling in the core network on S5/S8, Gx, and Gy simply to indicate the UEs initial PRA state. In a typical application (e.g., internet Access Point Name (APN)) with a PCRF, there may be only two PCRF Gx command/answer pairs without PRA reporting per PDN activation/deactivation lifetime. With PRA reporting, that is increased to three PCRF Gx command/answer pairs even if the UE never moves. With that extra required Gx (and Gy and S5/S8) signaling, an operator might not be able to use the current 3GPP PRA reporting feature.

Certain aspects of the present disclosure and their embodiments may provide solutions to the aforementioned or other challenges. Systems and methods for reducing signaling for Presence Reporting Area (PRA) state indication are disclosed. In some embodiments, a method performed by a first node for reducing signaling for PRA state indication includes determining whether a wireless device should be assumed to be in a PRA and indicating to a second node whether the wireless device is assumed to be in the PRA.

Some embodiments disclosed herein have the PCRF indicate “an initial presumed PRA state” for that PRA when first subscribing to a PRA.

A Mobility Management Entity (MME) (i.e., Authentication Management Functions (AMF)) on initially receiving the subscription to the PRA then does NOT send a PRA if the UE is actually in the same state as indicated by the “an initial presumed PRA state.” That means a Serving Gateway (SGW) will not trigger an extra S5/S8 Modify Bearer request. As a result, a Packet Gateway (PGW) will not trigger an extra Gx Credit

Control Request (CCR)-U and/or extra Gy CCR-U. Only when the UE is NOT in the “initial presumed state” will the MME indicate a change of state. After a first change of state from “an initial presumed PRA state,” then legacy call flows apply.

Some embodiments disclosed herein will eliminate extra signaling introduced by a PRA. Exact amounts depend on the size of the PRA. Specifically, for a very large PRA (i.e., the UE is likely to be in the PRA), the PCRF would set “an initial presumed PRA state” as “in PRA” when PCRF is subscribing, eliminating nearly 100% of the extra signaling. For a very small PRA (i.e., the UE is likely to be out of the PRA), the PCRF would set “an initial presumed PRA state” as “out of PRA” when the PCRF is subscribing, eliminating nearly 100% of the extra signaling. Assuming the operator/PCRF knows at least if the UE is more likely to be in or out of the PRA, the worst case is when the UE has a 50/50 chance to be in/out of the PRA and then savings by the embodiments is “only” 50% of the extra signaling. The value of this is clear.

Note: PCRF initially sets policy and charging rules based on “an initial presumed PRA state.” A primary point is using a “presumed initial PRA state” for a PRA to avoid the extra Gx/Gy/S5/S8 signaling. A secondary point is having PCRF be the one to set the value.

There are, proposed herein, various embodiments which address one or more of the issues disclosed herein. In some embodiments, a method performed by a first node for reducing signaling for PRA state indication includes determining whether a wireless device should be assumed to be in a PRA and indicating to a second node whether the wireless device is assumed to be in the PRA.

In some embodiments, the first node is a charging node such as a PCRF. In some embodiments, the second node is a Packet Gateway (PGW).

In some embodiments, determining whether the wireless device should be assumed to be in the PRA includes determining that the wireless device should be assumed to be in the PRA if the wireless device is more likely to be in the PRA. In some embodiments, determining whether the wireless device should be assumed to be in the PRA includes determining whether the wireless device should be assumed to be in the PRA based on the size of the PRA.

In some embodiments, the first node is a PGW, the second node is a SGW, and indicating to the second node whether the wireless device is assumed to be in the PRA comprises sending a Create Session Response to the SGW indicating whether the wireless device is assumed to be in the PRA.

In some embodiments, the first node is a SGW, the second node is a mobility node such as a MME, and indicating to the second node whether the wireless device is assumed to be in the PRA includes sending a Create Session Response to the mobility node indicating whether the wireless device is assumed to be in the PRA.

In some embodiments, indicating to the second node whether the wireless device is assumed to be in the PRA includes sending a PRA Action to the second node that indicates whether the wireless device is assumed to be in the PRA. In some embodiments, two bits in octet five of the PRA Action indicate whether the wireless device is assumed to be in the PRA. In some embodiments, a value of zero for the two bits indicates no presumption; a value of one for the two bits indicates the wireless device is assumed to be in the PRA; and a value of two for the two bits indicates the wireless device is assumed to be out of the PRA.

In some embodiments, the first node operates in a Long Term Evolution (LTE) network. In some embodiments, the first node operates in a Fifth Generation (5G) New Radio (NR) network

Certain embodiments may provide one or more of the following technical advantage(s).

This will eliminate extra signaling introduced by PRA. The exact amount of savings depends on the size of the PRA. Specifically, for a very large PRA (i.e., the UE is likely to be in the PRA) the PCRF would set the “initial presumed PRA state” as “in PRA” when PCRF is subscribing. This might eliminate nearly all of the extra signaling. For a very small PRA (i.e., the UE is likely to be out of the PRA) the PCRF would set the “initial presumed PRA state” as “out of PRA” when PCRF is subscribing. Again, this might eliminate nearly all of the extra signaling. Assuming the operator/PCRF knows at least if the UE is more likely to be in or out of the PRA, more than half of the signaling can be eliminated. The worst case is when UE has equal chance to be in/out of the PRA and then the savings is only half of the extra signaling, which is still significant. Also, no new signaling needs to be introduced. Only the equivalent of 2 bits of logical information needs to be added to existing messages, so the optimization is easy to implement.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell;”

however, particularly with respect to 5G NR concepts, beams may be used instead of cells and, as such, it is important to note that the concepts described herein are equally applicable to both cells and beams.

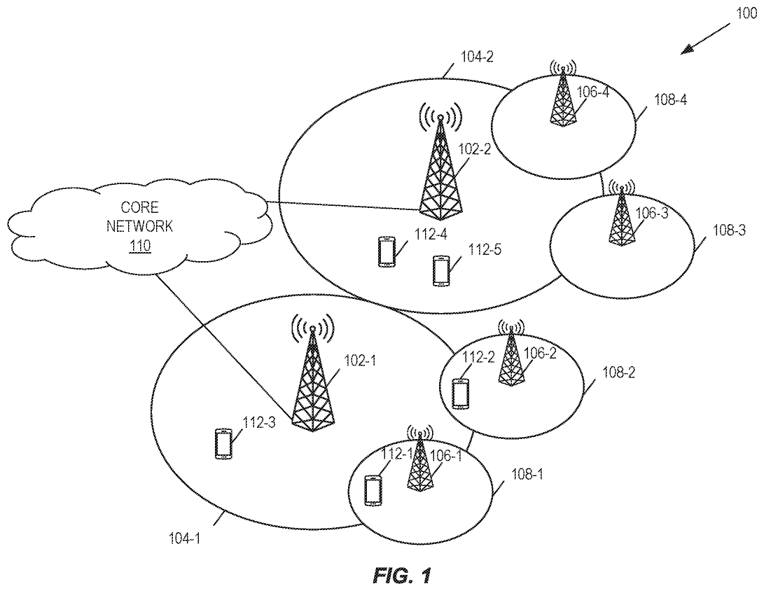

FIG. 1 illustrates one example of a cellular communications network 100 according to some embodiments of the present disclosure. In the embodiments described herein, the cellular communications network 100 is a 5G NR network. In this example, the cellular communications network 100 includes base stations 102-1 and 102-2, which in LTE are referred to as eNBs and in 5G NR are referred to as gNBs, controlling corresponding macro cells 104-1 and 104-2. The base stations 102-1 and 102-2 are generally referred to herein collectively as base stations 102 and individually as base station 102. Likewise, the macro cells 104-1 and 104-2 are generally referred to herein collectively as macro cells 104 and individually as macro cell 104. The cellular communications network 100 may also include a number of low power nodes 106-1 through 106-4 controlling corresponding small cells 108-1 through 108-4. The low power nodes 106-1 through 106-4 can be small base stations (such as pico or femto base stations) or Remote Radio Heads (RRHs), or the like. Notably, while not illustrated, one or more of the small cells 108-1 through 108-4 may alternatively be provided by the base stations 102. The low power nodes 106-1 through 106-4 are generally referred to herein collectively as low power nodes 106 and individually as low power node 106. Likewise, the small cells 108-1 through 108-4 are generally referred to herein collectively as small cells 108 and individually as small cell 108. The base stations 102 (and optionally the low power nodes 106) are connected to a core network 110.

The base stations 102 and the low power nodes 106 provide service to wireless devices 112-1 through 112-5 in the corresponding cells 104 and 108. The wireless devices 112-1 through 112-5 are generally referred to herein collectively as wireless devices 112 and individually as wireless device 112. The wireless devices 112 are also sometimes referred to herein as UEs.

As discussed above, when activated at attach/PDN procedures, there is currently extra signaling in the core network on S5/S8, Gx, and Gy simply to indicate the UE's initial PRA state. In a typical application (e.g., internet APN) with a PCRF, there may be only two

PCRF Gx command/answer pairs without PRA reporting per PDN activation/deactivation lifetime. With PRA reporting, that is increased to three PCRF Gx command/answer pairs even if the UE never moves. With that extra required Gx (and Gy and S5/S8) signaling, an operator might not be able to use the current 3GPP PRA reporting feature.

In some embodiments, the Gx reference point is located between the PCRF and the PCEF and may be used for provisioning and removal of Policy and Charging Control rules and the transmission of traffic plane events. The Gx reference point can be used for charging control, policy control or both by applying Attribute Value Pairs (AVPs) relevant to the application.

Certain aspects of the present disclosure and their embodiments may provide solutions to the aforementioned or other challenges. Systems and methods for reducing signaling for PRA state indication are disclosed. In some embodiments, a method performed by a first node for reducing signaling for PRA state indication includes determining whether a wireless device should be assumed to be in a PRA and indicating to a second node whether the wireless device is assumed to be in the PRA.

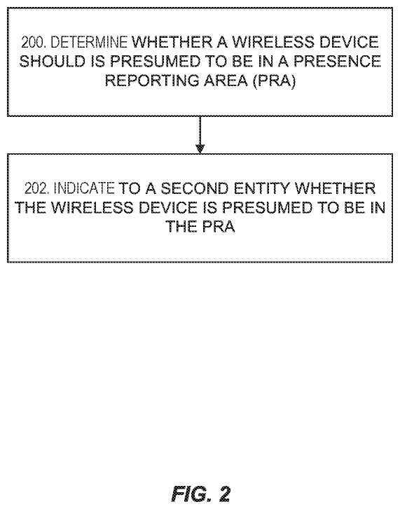

FIG. 2 shows this operation where the first node determining whether a wireless device should be assumed to be in a PRA (step 200) and indicating to a second node whether the wireless device is assumed to be in the PRA (step 202).

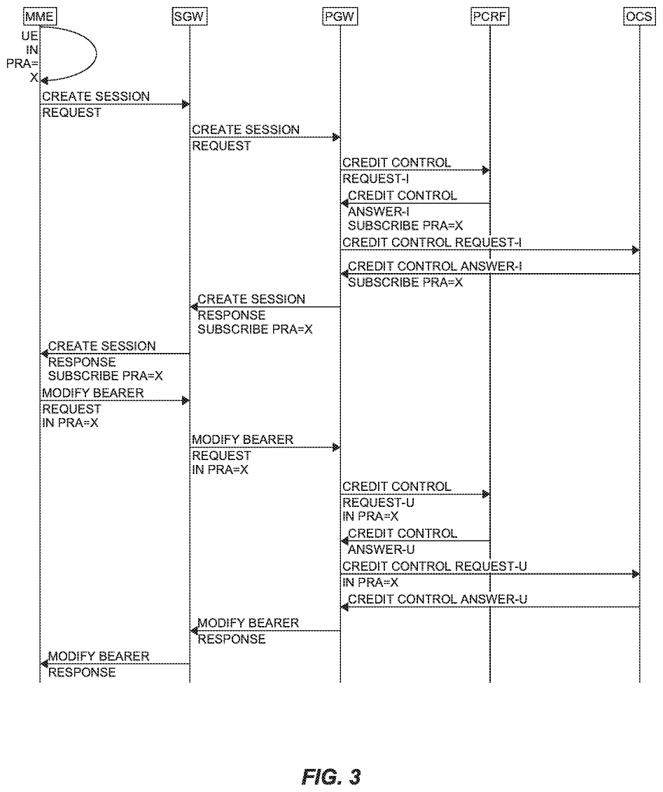

FIG. 3 shows the previous procedure for standalone PDN activation where the extra signaling is added when PRA is enabled. That normally has no Gx or Gy signaling after the Create Session Response. However, with PRA enabled at PDN activation there is extra Gx signaling. A simplified view with the relevant parts for discussion (for attach or PDN activation) is shown in FIG. 3. At first, the MME does not know if the UE is in the PRA or not. There is a Create Session Request sent to the SGW and then also sent to the PGW. The PGW sends a Credit Control Request (CCR) to the PCRF and receives a Credit Control Answer. The PGW also sends a CCR to the OCS and receives a Credit Control Answer. A Create Session Response is sent to the SGW and also to the MME. When the MME needs to modify the bearer request, these signals are again performed. This requires considerable signaling.

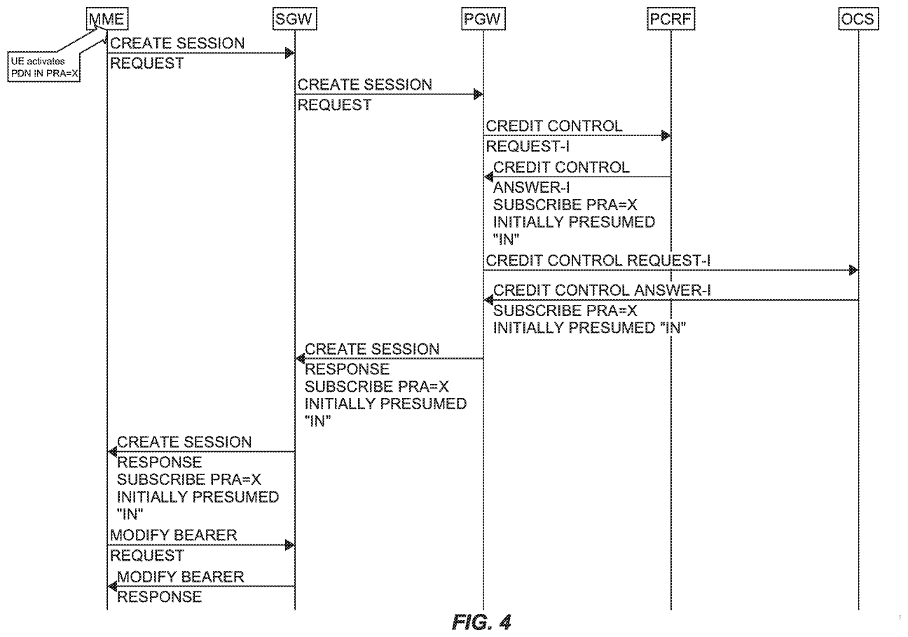

FIG. 4 illustrates an embodiment of the current disclosure where the UE is initially presumed to be in the PRA. A simplified view with the relevant parts for discussion (for attach or PDN activation) is shown in FIG. 4. FIG. 4 shows the same flow as FIG. 3 except that the embodiments disclosed herein allow the PCRF to indicate that the UE is presumed to be “in” the PRA. In this case, the overall signaling is reduced if the UE is in the PRA as assumed. If the UE changes whether it is in or out of the PRA, legacy mechanisms can be used to indicate the changes.

While FIG. 4 presumes that the UE is initially in the PRA, an analogous call flow applies if “in” is replaced with “out” everywhere. In that case, the system would initially presume the UE to be out of the PRA. In some embodiments, the original call flow (such as in FIG. 3) starting at the Modify Bearer Request applies when UE is “in” but PCRF uses “out” or UE is “out” and PCRF uses “in.” That is, once the state change has occurred, the initial presumed value is no longer used (i.e., legacy call flow signals PRA state changes).

As discussed above, if an implicitly assumed state (in or out) is indicated from PCRF to PGW to MME/S4-SGSN for this PRA, unneeded signaling can be avoided in a fraction of use cases (typically 50% to 100% of use cases). The only information the operator needs to know to fully benefit from this feature is if on average the UEs are more likely to be “in” or “out” for the PRA. Even without that knowledge, there is reduction of signaling. Also note that these embodiments also apply in other use cases. In some embodiments, no change in message format is required on GTPv2-C for this feature. In some embodiments, a small encoding addition to an existing Information Element (IE) should be sufficient for the main functionality.

From 3GPP TS 29.274: “Evolved General Packet Radio Service (GPRS) Tunnelling Protocol for Control plane (GTPv2-C)”:

TABLE 1
Presence Reporting Area Action

| | Bits | | | | | | | |
|---|---|---|---|---|---|---|---|---|
| Octets | 8 | 7 | 6 | 5 | 4 | 3 | 2 | 1 |

| 1 | Type = 177 | | |
|---|---|---|---|
| 2 to 3 | Length = n | | |
| 4 | Spare | Instance | |
| 5 | Spare | INAPRA | Action |

| 6 to 8 | Presence Reporting Area Identifier | |
|---|---|---|
| 9 | Number of TAI | Number of RAI |

| 10 | Spare | Number of Macro eNodeB |
|---|---|---|
| 11 | Spare | Number of Home eNodeB |
| 12 | Spare | Number of ECGI |
| 13 | Spare | Number of SAI |
| 14 | Spare | Number of CGI |
| 15 to k | TAIs [1 . . . 15] | |
| (k + 1) to m | Macro eNB IDs [1 . . . 63] | |
| (m + 1) to p | Home eNB IDs [1 . . . 63] | |
| (p + 1) to q | ECGIs [1 . . . 63] | |
| (q + 1) to r | RAIs [1 . . . 15] | |
| (r + 1) to s | SAIs [1 . . . 63] | |
| (s + 1) to t | CGIs [1 . . . 63] | |
| t + 1 | Spare | Number of Extended Macro |
| | | eNodeB |

| | |
|---|---|
| (t + 2) to v | Extended Macro eNB IDs [1 . . . 63] |
| u to (n + 4) | These octet(s) is/are present only if explicitly |
| | specified |

The above IE is already sent from PGW->SGW->MME. Two of the spare bits in octet 5 are a logical candidate. Those 2 bits can be: 0=legacy usage (i.e., no presumed value); 1=Presumed “in”; 2=Presumed “out”; 3=Reserved.

Optionally, an indication of “MME” support and “SGW” support can be in a bit in the indication IE.

Note on S10/S3/S16/N26, when above IE is passed, the old MME/AMF indicates the last reported PRA state. For inter-MME/intra-SGW cases, this avoids useless S5/S8 signaling.

On diameter (Gx and Gy) the existing AVP is fortunately already suitably set.

### Presence-Reporting-Area-Information::=<AVP Header: 2822>

[Presence-Reporting-Area-Identifier]
[Presence-Reporting-Area-Status]
[Presence-Reporting-Area-Elements-List]
*[AVP]

Today, Presence-Reporting-Area-Status (value 0 is “in,” 1 is “out”) inside the above AVP is sent only in PGW->PCRF and PGW->OCS direction. By simply including in the Presence-Reporting-Area-Status towards PGW, AVP can indicate both the “presumed PRA state” and support of feature on PCRF/OCS towards the PGW.

Optionally, a bit in the Supported-Features AVP can be used to indicate PGW support to PCRF/OCS.

Without 3GPP standards changes, there is a viable but less desirable option. In some embodiments, a local MME configuration sets the presumed “in” or “out” per PRA value (or possibly by range of PRA). The same flow diagrams apply, but the presumed value is not sent from the PCRF but locally set on the MME. Some embodiments disclosed herein cover that static method. However, these embodiments may make it difficult to:
a) have one class of UEs be presumed “in” and another class of UE be presumed “out” for the same PRA number;
b) use legacy call flow for a class of UEs (that may apply when PCRF has three policy needed (unknown PRA state, in PRA, out of PRA) for business reasons);
c) have mixed support of this feature in the network;
d) have SGW and PGW not know the “presumed” initial state—they currently use “PRA” in uplink, so in call flow they never receive it. So to have correct data on offline charging, those nodes need to either have static configuration as well or use the downlink provided PRA and presumed state from PCRF as in the above call flows.

Generally a static configuration PRA solution has functional impacts to SGW/PGW, so a 3GPP standard approach is preferred. The above technique applies to other use cases than PDN activation.

PCRF can enable a PRA well after a PDN activation as shown in FIG. 5A. FIG. 5A shows an example that includes additional signaling.

While the previous discussions focused on the interactions of the PCRF Policy Control Function (PCF) and the MME, these embodiments are equally applicable to NR or 5G network architecture scenarios. FIG. 5B illustrates a procedure similar to FIG. 5A in a NR context, according to some embodiments of the present disclosure. FIG. 5B illustrates PRA reporting at AMF<->PCF session establishment. This is similar to that discussed in 3GPP TS 29.507.

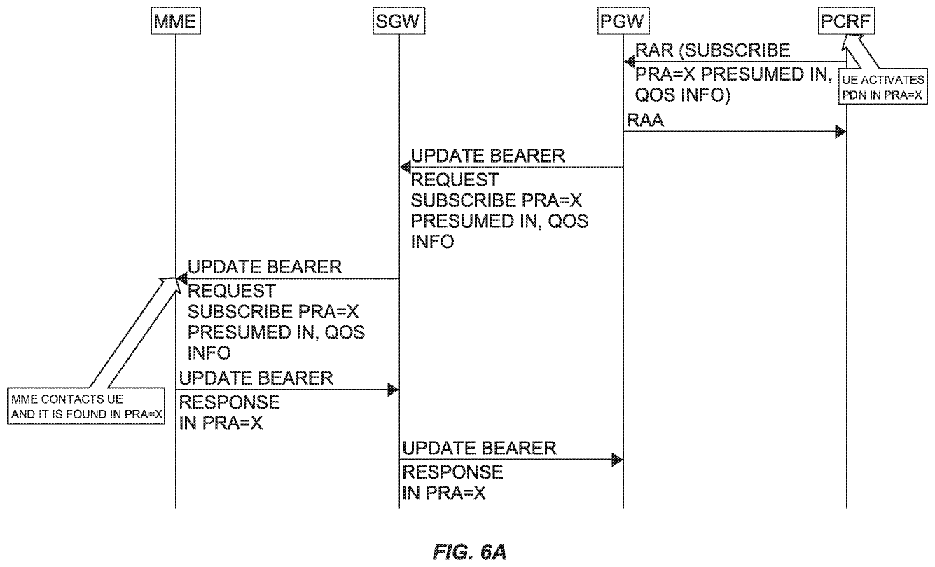

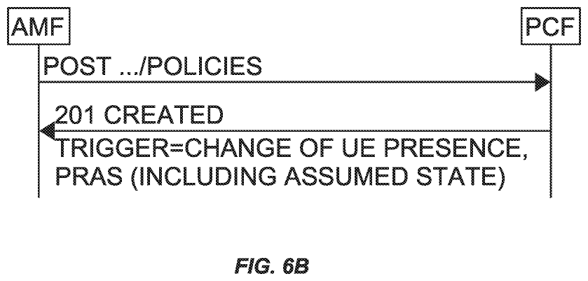

FIG. 6A shows the same procedure as FIG. 5A, but with the assumption that the UE is in the PRA. This leads to a reduction in the signaling.

Additional details regarding some of the mechanisms discussed herein can be found in 3GPP TS 29.212: “Policy and Charging Control (PCC); Reference points” and 3GPP TS 32.251: “Telecommunication Management; Charging Management; Packet Switched (PS) domain charging.”

FIG. 6B illustrates the same procedure as FIG. 5B, but with the assumption that the PRA state is the same as the “presumed” PRA state, according to some embodiments of the present disclosure. In some embodiments, the Session Management Function (SMF) will have to report the PRA in a procedure other than the policy association creation. So, in some embodiments, the same 50% reduction in signaling between SMF and PCF is available as was present between PGW and PCRF over the Gx protocol. In some embodiments, the 201 in the policy creation includes a new field (value in or out) in the “repPraInfos” or adds JSON field/attribute “repPraInfos” to indicate the PRA state to act as if it were sent by SMF to PCF (presumed/assumed state). Other mechanisms such as local configuration on SMF (or AMF) are possible as well to suppress the report when the “presumed/assumed” PRA is the PRA the UE is presently in. In some embodiments, there is a similar optimization for the procedure when the PCF enables a PRA well after the session is established.

In some embodiments, a 204 “No content” response occurs on fully successful procedures, so there is no provision to return PRA back from SMF (and if UE needs paged the PRA info may delay the response here). In these cases, the presumed PRA state in the POST request from PCF cleanly deals with this as well.

In cases where there is a change of UE presence in PRA and/or the change of UE presence in PRA trigger occurs, the AMF shall only invoke the procedure if the PCF has subscribed to that event trigger. If the Policy Control Request Trigger “Change of UE presence in PRA” is provided, the presence reporting areas for which reporting was requested and the status has changed is encoded as a “praStatuses” attribute. Again, the 201 response at the policy session establishment between AMF and PCF only allows for triggering PRA reports. So at UE initial registration there is a potential to reduce signaling messages by 50% again. In some embodiments, this would be accomplished by including “praStatuses” as the presumed/assumed state in the 201 response when the PRA reporting is turned on.

FIG. 7 illustrates a wireless communication system represented as a 5G network architecture composed of core Network Functions (NFs), where interaction between any two NFs is represented by a point-to-point reference point/interface. FIG. 7 can be viewed as one particular implementation of the system 100 of FIG. 1.

Seen from the access side the 5G network architecture shown in FIG. 7 comprises a plurality of User Equipment (UEs) connected to either a Radio Access Network (RAN) or an Access Network (AN) as well as an Access and Mobility Management Function (AMF). Typically, the R(AN) comprises base stations, e.g. such as evolved Node Bs (eNBs) or 5G base stations (gNBs) or similar. Seen from the core network side, the 5G core NFs shown in FIG. 7 include a Network Slice Selection Function (NSSF), an Authentication Server Function (AUSF), a Unified Data Management (UDM), an AMF, a Session Management Function (SMF), a Policy Control Function (PCF), and an Application Function (AF).

Reference point representations of the 5G network architecture are used to develop detailed call flows in the normative standardization. The N1 reference point is defined to carry signaling between the UE and AMF. The reference points for connecting between the AN and AMF and between the AN and UPF are defined as N2 and N3, respectively. There is a reference point, N11, between the AMF and SMF, which implies that the SMF is at least partly controlled by the AMF. N4 is used by the SMF and UPF so that the UPF can be set using the control signal generated by the SMF, and the UPF can report its state to the SMF. N9 is the reference point for the connection between different UPFs, and N14 is the reference point connecting between different AMFs, respectively. N15 and N7 are defined since the PCF applies policy to the AMF and SMP, respectively. N12 is required for the AMF to perform authentication of the UE. N8 and N10 are defined because the subscription data of the UE is required for the AMF and SMF.

The 5G core network aims at separating user plane and control plane. The user plane carries user traffic while the control plane carries signaling in the network. In FIG. 7, the UPF is in the user plane and all other NFs, i.e., the AMF, SMF, PCF, AF, AUSF, and UDM, are in the control plane. Separating the user and control planes guarantees each plane resource to be scaled independently. It also allows UPFs to be deployed separately from control plane functions in a distributed fashion. In this architecture, UPFs may be deployed very close to UEs to shorten the Round Trip Time (RTT) between UEs and data network for some applications requiring low latency.

The core 5G network architecture is composed of modularized functions. For example, the AMF and SMF are independent functions in the control plane. Separated AMF and SMF allow independent evolution and scaling. Other control plane functions like the PCF and AUSF can be separated as shown in FIG. 7. Modularized function design enables the 5G core network to support various services flexibly.

Each NF interacts with another NF directly. It is possible to use intermediate functions to route messages from one NF to another NF. In the control plane, a set of interactions between two NFs is defined as service so that its reuse is possible. This service enables support for modularity. The user plane supports interactions such as forwarding operations between different UPFs.

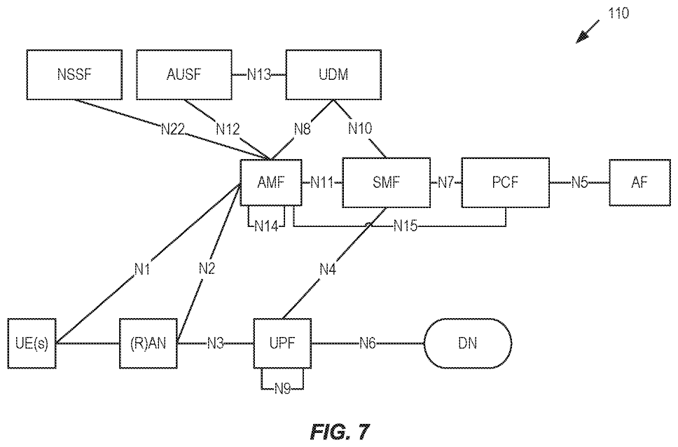

FIG. 8 illustrates a 5G network architecture using service-based interfaces between the NFs in the control plane, instead of the point-to-point reference points/interfaces used in the 5G network architecture of FIG. 7. However, the NFs described above with reference to FIG. 7 correspond to the NFs shown in FIG. 8. The service(s) etc. that a NF provides to other authorized NFs can be exposed to the authorized NFs through the service-based interface. In FIG. 8 the service based interfaces are indicated by the letter “N” followed by the name of the NF, e.g. Namf for the service based interface of the AMF and Nsmf for the service based interface of the SMF etc. The Network Exposure Function (NEF) and the Network Repository Function (NRF) in FIG. 8 are not shown in FIG. 7 discussed above. However, it should be clarified that all NFs depicted in FIG. 7 can interact with the NEF and the NRF of FIG. 8 as necessary, though not explicitly indicated in FIG. 7.

Some properties of the NFs shown in FIGS. 7 and 8 may be described in the following manner. The AMF provides UE-based authentication, authorization, mobility management, etc. A UE even using multiple access technologies is basically connected to a single AMF because the AMF is independent of the access technologies. The SMF is responsible for session management and allocates Internet Protocol (IP) addresses to UEs. It also selects and controls the UPF for data transfer. If a UE has multiple sessions, different SMFs may be allocated to each session to manage them individually and possibly provide different functionalities per session. The AF provides information on the packet flow to the PCF responsible for policy control in order to support Quality of Service (QoS). Based on the information, the PCF determines policies about mobility and session management to make the AMF and SMF operate properly. The AUSF supports authentication function for UEs or similar and thus stores data for authentication of UEs or similar while the UDM stores subscription data of the UE. The Data Network (DN), not part of the 5G core network, provides Internet access or operator services and similar.

An NF may be implemented either as a network element on a dedicated hardware, as a software instance running on a dedicated hardware, or as a virtualized function instantiated on an appropriate platform, e.g., a cloud infrastructure.

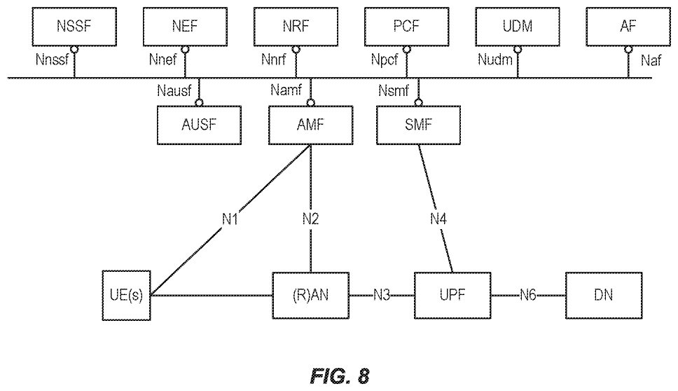

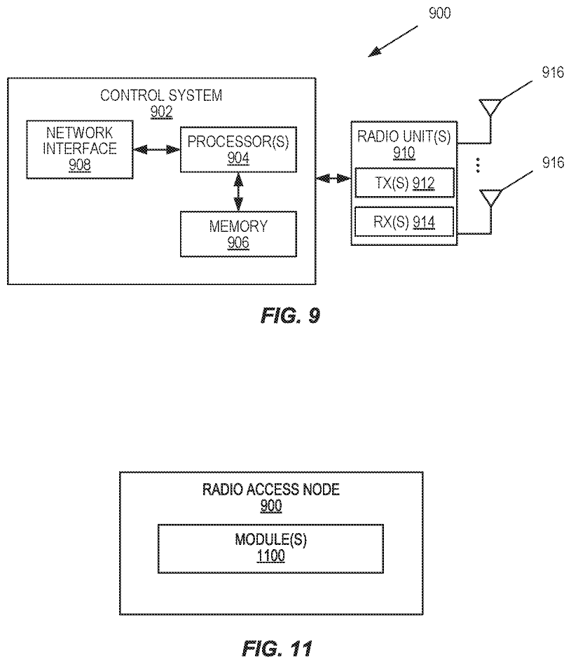

FIG. 9 is a schematic block diagram of a radio access node 900 according to some embodiments of the present disclosure. The radio access node 900 may be, for example, a base station 102 or low power node 106. As illustrated, the radio access node 900 includes a control system 902 that includes one or more processors 904 (e.g., Central Processing Units (CPUs), Application Specific Integrated Circuits (ASICs), Field Programmable Gate Arrays (FPGAs), and/or the like), memory 906, and a network interface 908. The one or more processors 904 are also referred to herein as processing circuitry. In addition, the radio access node 900 includes one or more radio units 910 that each includes one or more transmitters 912 and one or more receivers 914 coupled to one or more antennas 916. The radio units 910 may be referred to or be part of radio interface circuitry. In some embodiments, the radio unit(s) 910 is external to the control system 902 and connected to the control system 902 via, e.g., a wired connection (e.g., an optical cable). However, in some other embodiments, the radio unit(s) 910 and potentially the antenna(s) 916 are integrated together with the control system 902. The one or more processors 904 operate to provide one or more functions of a radio access node 900 as described herein. In some embodiments, the function(s) are implemented in software that is stored, e.g., in the memory 906 and executed by the one or more processors 904.

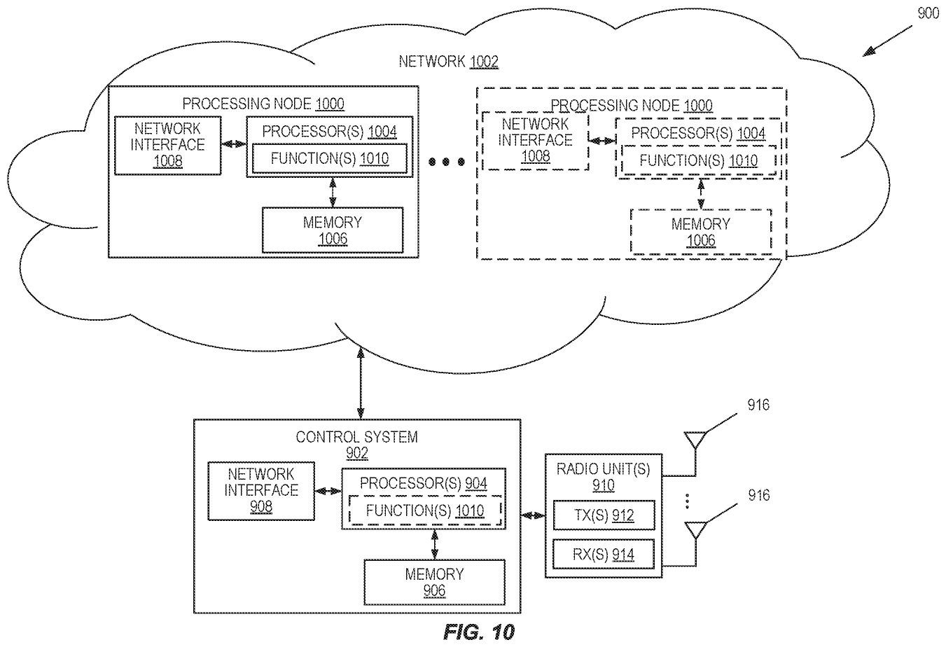

FIG. 10 is a schematic block diagram that illustrates a virtualized embodiment of the radio access node 900 according to some embodiments of the present disclosure. This discussion is equally applicable to other types of network nodes. Further, other types of network nodes may have similar virtualized architectures.

As used herein, a “virtualized” radio access node is an implementation of the radio access node 900 in which at least a portion of the functionality of the radio access node 900 is implemented as a virtual component(s) (e.g., via a virtual machine(s) executing on a physical processing node(s) in a network(s)). As illustrated, in this example, the radio access node 900 includes the control system 902 that includes the one or more processors 904 (e.g., CPUs, ASICs, FPGAs, and/or the like), the memory 906, and the network interface 908 and the one or more radio units 910 that each includes the one or more transmitters 912 and the one or more receivers 914 coupled to the one or more antennas 916, as described above. The control system 902 is connected to the radio unit(s) 910 via, for example, an optical cable or the like. The control system 902 is connected to one or more processing nodes 1000 coupled to or included as part of a network(s) 1002 via the network interface 908. Each processing node 1000 includes one or more processors 1004 (e.g., CPUs, ASICs, FPGAs, and/or the like), memory 1006, and a network interface 1008.

In this example, functions 1010 of the radio access node 900 described herein are implemented at the one or more processing nodes 1000 or distributed across the control system 902 and the one or more processing nodes 1000 in any desired manner. In some particular embodiments, some or all of the functions 1010 of the radio access node 900 described herein are implemented as virtual components executed by one or more virtual machines implemented in a virtual environment(s) hosted by the processing node(s) 1000. As will be appreciated by one of ordinary skill in the art, additional signaling or communication between the processing node(s) 1000 and the control system 902 is used in order to carry out at least some of the desired functions 1010. Notably, in some embodiments, the control system 902 may not be included, in which case the radio unit(s) 910 communicate directly with the processing node(s) 1000 via an appropriate network interface(s).

In some embodiments, a computer program including instructions which, when executed by at least one processor, causes the at least one processor to carry out the functionality of radio access node 900 or a node (e.g., a processing node 1000) implementing one or more of the functions 1010 of the radio access node 900 in a virtual environment according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 11 is a schematic block diagram of the radio access node 900 according to some other embodiments of the present disclosure. The radio access node 900 includes one or more modules 1100, each of which is implemented in software. The module(s) 1100 provide the functionality of the radio access node 900 described herein. This discussion is equally applicable to the processing node 1000 of FIG. 10 where the modules 1100 may be implemented at one of the processing nodes 1000 or distributed across multiple processing nodes 1000 and/or distributed across the processing node(s) 1000 and the control system 902.

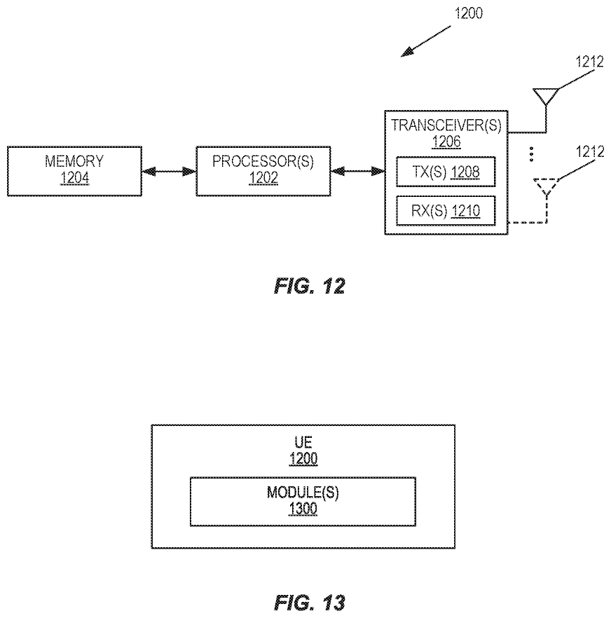

FIG. 12 is a schematic block diagram of a UE 1200 according to some embodiments of the present disclosure. As illustrated, the UE 1200 includes one or more processors 1202 (e.g., CPUs, ASICs, FPGAs, and/or the like), memory 1204, and one or more transceivers 1206 each including one or more transmitters 1208 and one or more receivers 1210 coupled to one or more antennas 1212. The transceiver(s) 1206 includes radio-front end circuitry connected to the antenna(s) 1212 that is configured to condition signals communicated between the antenna(s) 1212 and the processor(s) 1202, as will be appreciated by on of ordinary skill in the art. The processors 1202 are also referred to herein as processing circuitry. The transceivers 1206 are also referred to herein as radio circuitry. In some embodiments, the functionality of the UE 1200 described above may be fully or partially implemented in software that is, e.g., stored in the memory 1204 and executed by the processor(s) 1202. Note that the UE 1200 may include additional components not illustrated in FIG. 12 such as, e.g., one or more user interface components (e.g., an input/output interface including a display, buttons, a touch screen, a microphone, a speaker(s), and/or the like and/or any other components for allowing input of information into the UE 1200 and/or allowing output of information from the UE 1200), a power supply (e.g., a battery and associated power circuitry), etc.

In some embodiments, a computer program including instructions which, when executed by at least one processor, causes the at least one processor to carry out the functionality of the UE 1200 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

FIG. 13 is a schematic block diagram of the UE 1200 according to some other embodiments of the present disclosure. The UE 1200 includes one or more modules 1300, each of which is implemented in software. The module(s) 1300 provide the functionality of the UE 1200 described herein.

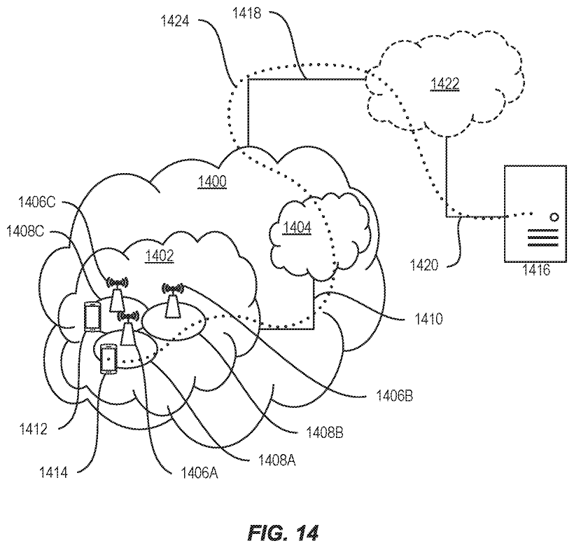

With reference to FIG. 14, in accordance with an embodiment, a communication system includes a telecommunication network 1400, such as a 3GPP-type cellular network, which comprises an access network 1402, such as a RAN, and a core network 1404. The access network 1402 comprises a plurality of base stations 1406A, 1406B, 1406C, such as NBs, eNBs, gNBs, or other types of wireless Access Points (APs), each defining a corresponding coverage area 1408A, 1408B, 1408C. Each base station 1406A, 1406B, 1406C is connectable to the core network 1404 over a wired or wireless connection 1410. A first UE 1412 located in coverage area 1408C is configured to wirelessly connect to, or be paged by, the corresponding base station 1406C. A second UE 1414 in coverage area 1408A is wirelessly connectable to the corresponding base station 1406A. While a plurality of UEs 1412, 1414 are illustrated in this example, the disclosed embodiments are equally applicable to a situation where a sole UE is in the coverage area or where a sole UE is connecting to the corresponding base station 1406.

The telecommunication network 1400 is itself connected to a host computer 1416, which may be embodied in the hardware and/or software of a standalone server, a cloud-implemented server, a distributed server, or as processing resources in a server farm. The host computer 1416 may be under the ownership or control of a service provider, or may be operated by the service provider or on behalf of the service provider. Connections 1418 and 1420 between the telecommunication network 1400 and the host computer 1416 may extend directly from the core network 1404 to the host computer 1416 or may go via an optional intermediate network 1422. The intermediate network 1422 may be one of, or a combination of more than one of, a public, private, or hosted network; the intermediate network 1422, if any, may be a backbone network or the Internet; in particular, the intermediate network 1422 may comprise two or more sub-networks (not shown).

The communication system of FIG. 14 as a whole enables connectivity between the connected UEs 1412, 1414 and the host computer 1416. The connectivity may be described as an Over-the-Top (OTT) connection 1424. The host computer 1416 and the connected UEs 1412, 1414 are configured to communicate data and/or signaling via the OTT connection 1424, using the access network 1402, the core network 1404, any intermediate network 1422, and possible further infrastructure (not shown) as intermediaries. The OTT connection 1424 may be transparent in the sense that the participating communication devices through which the OTT connection 1424 passes are unaware of routing of uplink and downlink communications. For example, the base station 1406 may not or need not be informed about the past routing of an incoming downlink communication with data originating from the host computer 1416 to be forwarded (e.g., handed over) to a connected UE 1412. Similarly, the base station 1406 need not be aware of the future routing of an outgoing uplink communication originating from the UE 1412 towards the host computer 1416.

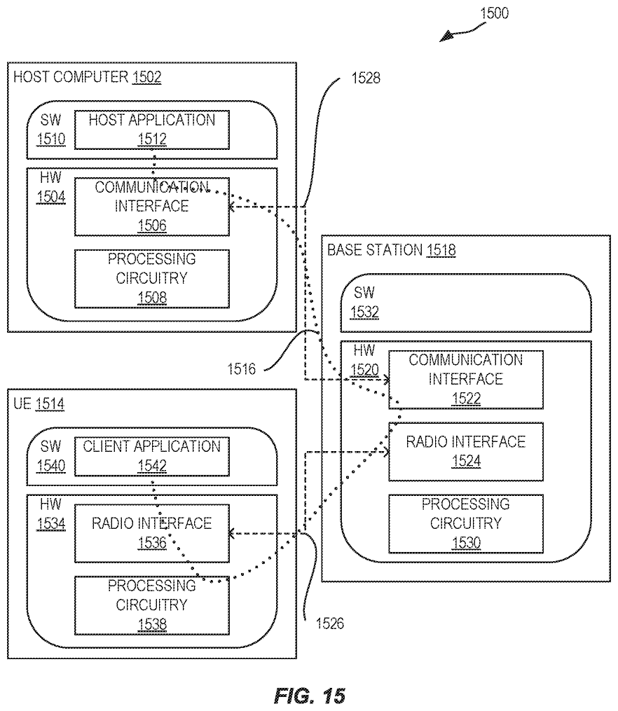

Example implementations, in accordance with an embodiment, of the UE, base station, and host computer discussed in the preceding paragraphs will now be described with reference to FIG. 15. In a communication system 1500, a host computer 1502 comprises hardware 1504 including a communication interface 1506 configured to set up and maintain a wired or wireless connection with an interface of a different communication device of the communication system 1500. The host computer 1502 further comprises processing circuitry 1508, which may have storage and/or processing capabilities. In particular, the processing circuitry 1508 may comprise one or more programmable processors, ASICs, FPGAs, or combinations of these (not shown) adapted to execute instructions. The host computer 1502 further comprises software 1510, which is stored in or accessible by the host computer 1502 and executable by the processing circuitry 1508. The software 1510 includes a host application 1512. The host application 1512 may be operable to provide a service to a remote user, such as a UE 1514 connecting via an OTT connection 1516 terminating at the UE 1514 and the host computer 1502. In providing the service to the remote user, the host application 1512 may provide user data which is transmitted using the OTT connection 1516.

The communication system 1500 further includes a base station 1518 provided in a telecommunication system and comprising hardware 1520 enabling it to communicate with the host computer 1502 and with the UE 1514. The hardware 1520 may include a communication interface 1522 for setting up and maintaining a wired or wireless connection with an interface of a different communication device of the communication system 1500, as well as a radio interface 1524 for setting up and maintaining at least a wireless connection 1526 with the UE 1514 located in a coverage area (not shown in FIG. 15) served by the base station 1518. The communication interface 1522 may be configured to facilitate a connection 1528 to the host computer 1502. The connection 1528 may be direct or it may pass through a core network (not shown in FIG. 15) of the telecommunication system and/or through one or more intermediate networks outside the telecommunication system. In the embodiment shown, the hardware 1520 of the base station 1518 further includes processing circuitry 1530, which may comprise one or more programmable processors, ASICs, FPGAs, or combinations of these (not shown) adapted to execute instructions. The base station 1518 further has software 1532 stored internally or accessible via an external connection.

The communication system 1500 further includes the UE 1514 already referred to. The UE's 1514 hardware 1534 may include a radio interface 1536 configured to set up and maintain a wireless connection 1526 with a base station serving a coverage area in which the UE 1514 is currently located. The hardware 1534 of the UE 1514 further includes processing circuitry 1538, which may comprise one or more programmable processors, ASICs, FPGAs, or combinations of these (not shown) adapted to execute instructions. The UE 1514 further comprises software 1540, which is stored in or accessible by the UE 1514 and executable by the processing circuitry 1538. The software 1540 includes a client application 1542. The client application 1542 may be operable to provide a service to a human or non-human user via the UE 1514, with the support of the host computer 1502. In the host computer 1502, the executing host application 1512 may communicate with the executing client application 1542 via the OTT connection 1516 terminating at the UE 1514 and the host computer 1502. In providing the service to the user, the client application 1542 may receive request data from the host application 1512 and provide user data in response to the request data. The OTT connection 1516 may transfer both the request data and the user data. The client application 1542 may interact with the user to generate the user data that it provides.

It is noted that the host computer 1502, the base station 1518, and the UE 1514 illustrated in FIG. 15 may be similar or identical to the host computer 1416, one of the base stations 1406A, 1406B, 1406C, and one of the UEs 1412, 1414 of FIG. 14, respectively. This is to say, the inner workings of these entities may be as shown in FIG. 15 and independently, the surrounding network topology may be that of FIG. 14.

In FIG. 15, the OTT connection 1516 has been drawn abstractly to illustrate the communication between the host computer 1502 and the UE 1514 via the base station 1518 without explicit reference to any intermediary devices and the precise routing of messages via these devices. The network infrastructure may determine the routing, which may be configured to hide from the UE 1514 or from the service provider operating the host computer 1502, or both. While the OTT connection 1516 is active, the network infrastructure may further take decisions by which it dynamically changes the routing (e.g., on the basis of load balancing consideration or reconfiguration of the network).

The wireless connection 1526 between the UE 1514 and the base station 1518 is in accordance with the teachings of the embodiments described throughout this disclosure. One or more of the various embodiments improve the performance of OTT services provided to the UE 1514 using the OTT connection 1516, in which the wireless connection 1526 forms the last segment. More precisely, the teachings of these embodiments may improve the data rate, latency, and/or power consumption by reducing signaling and thereby provide benefits such as reduced user waiting time, relaxed restriction on file size, better responsiveness, and/or extended battery.

A measurement procedure may be provided for the purpose of monitoring data rate, latency, and other factors on which the one or more embodiments improve. There may further be an optional network functionality for reconfiguring the OTT connection 1516 between the host computer 1502 and the UE 1514, in response to variations in the measurement results. The measurement procedure and/or the network functionality for reconfiguring the OTT connection 1516 may be implemented in the software 1510 and the hardware 1504 of the host computer 1502 or in the software 1540 and the hardware 1534 of the UE 1514, or both. In some embodiments, sensors (not shown) may be deployed in or in association with communication devices through which the OTT connection 1516 passes; the sensors may participate in the measurement procedure by supplying values of the monitored quantities exemplified above, or supplying values of other physical quantities from which the software 1510, 1540 may compute or estimate the monitored quantities. The reconfiguring of the OTT connection 1516 may include message format, retransmission settings, preferred routing, etc.; the reconfiguring need not affect the base station 1518, and it may be unknown or imperceptible to the base station 1518. Such procedures and functionalities may be known and practiced in the art. In certain embodiments, measurements may involve proprietary UE signaling facilitating the host computer 1502′s measurements of throughput, propagation times, latency, and the like. The measurements may be implemented in that the software 1510 and 1540 causes messages to be transmitted, in particular empty or ‘dummy’ messages, using the OTT connection 1516 while it monitors propagation times, errors, etc.

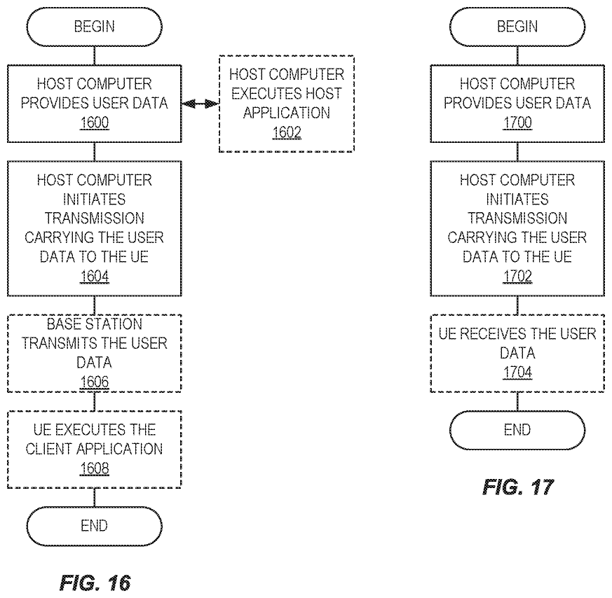

FIG. 16 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 16 will be included in this section. In step 1600, the host computer provides user data. In sub-step 1602 (which may be optional) of step 1600, the host computer provides the user data by executing a host application. In step 1604, the host computer initiates a transmission carrying the user data to the UE. In step 1606 (which may be optional), the base station transmits to the UE the user data which was carried in the transmission that the host computer initiated, in accordance with the teachings of the embodiments described throughout this disclosure. In step 1608 (which may also be optional), the UE executes a client application associated with the host application executed by the host computer.

FIG. 17 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 17 will be included in this section. In step 1700 of the method, the host computer provides user data. In an optional sub-step (not shown) the host computer provides the user data by executing a host application. In step 1702, the host computer initiates a transmission carrying the user data to the UE. The transmission may pass via the base station, in accordance with the teachings of the embodiments described throughout this disclosure. In step 1704 (which may be optional), the UE receives the user data carried in the transmission.

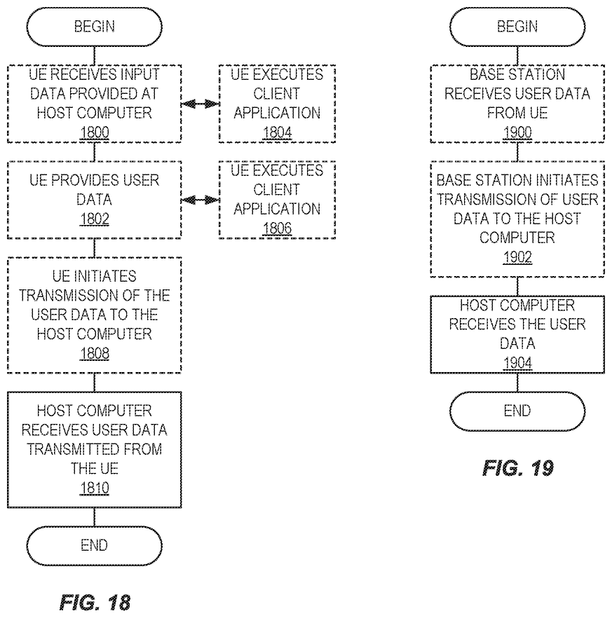

FIG. 18 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 18 will be included in this section. In step 1800 (which may be optional), the UE receives input data provided by the host computer. Additionally or alternatively, in step 1802 (which may be optional), the UE provides user data. In sub-step 1804 (which may be optional) of step 1800, the UE provides the user data by executing a client application. In sub-step 1806 (which may be optional) of step 1802, the UE executes a client application which provides the user data in reaction to the received input data provided by the host computer. In providing the user data, the executed client application may further consider user input received from the user. Regardless of the specific manner in which the user data was provided, the UE initiates, in sub-step 1808 (which may be optional), transmission of the user data to the host computer. In step 1810 of the method, the host computer receives the user data transmitted from the UE, in accordance with the teachings of the embodiments described throughout this disclosure.

FIG. 19 is a flowchart illustrating a method implemented in a communication system, in accordance with one embodiment. The communication system includes a host computer, a base station, and a UE which may be those described with reference to FIGS. 14 and 15. For simplicity of the present disclosure, only drawing references to FIG. 19 will be included in this section. In step 1900 (which may be optional), in accordance with the teachings of the embodiments described throughout this disclosure, the base station receives user data from the UE. In step 1902 (which may be optional), the base station initiates transmission of the received user data to the host computer. In step 1904 (which may be optional), the host computer receives the user data carried in the transmission initiated by the base station.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessor or microcontrollers, as well as other digital hardware, which may include Digital Signal Processor (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

### Embodiments

### Group A Embodiments

1. A method performed by a first node for reducing signaling for Presence Reporting Area, PRA, state indication, the method comprising:
   determining (200) whether a wireless device should be assumed to be in a PRA; and
   indicating (202) to a second node whether the wireless device is assumed to be in the PRA.
2. The method of embodiment 1, wherein the first node is a charging node such as a Policy and Charging Rules Function, PCRF.
3. The method of any of embodiments 1 to 2, wherein the second node is a Packet Gateway, PGW.
4. The method of any of embodiments 1 to 3, wherein determining whether the wireless device should be assumed to be in the PRA comprises determining that the wireless device should be assumed to be in the PRA if the wireless device is more likely to be in the PRA.
5. The method of any of embodiments 1 to 4, wherein determining whether the wireless device should be assumed to be in the PRA comprises determining whether the wireless device should be assumed to be in the PRA based on a size of the PRA.
6. The method of embodiment 1, wherein the first node is a Packet Gateway, PGW, the second node is a Serving Gateway, SGW, and indicating to the second node whether the wireless device is assumed to be in the PRA comprises sending a Create Session Response to the SGW indicating whether the wireless device is assumed to be in the PRA.
7. The method of embodiment 1, wherein the first node is a Serving Gateway, SGW, the second node is a mobility node such as a Mobility Management Entity, MME, and indicating to the second node whether the wireless device is assumed to be in the PRA comprises sending a Create Session Response to the mobility node indicating whether the wireless device is assumed to be in the PRA.
8. The method of any of embodiments 1 to 7, wherein indicating to the second node whether the wireless device is assumed to be in the PRA comprises sending a PRA Action to the second node that indicates whether the wireless device is assumed to be in the PRA.
9. The method of embodiment 8, wherein two bits in octet five of the PRA Action indicates whether the wireless device is assumed to be in the PRA.
10. The method of embodiment 9, wherein: a value of zero for the two bits indicates no presumption; a value of one for the two bits indicates the wireless device is assumed to be in the PRA; and a value of two for the two bits indicates the wireless device is assumed to be out of the PRA.
11. The method of any of embodiments 1 to 10, wherein the first node operates in a Long Term Evolution, LTE, network.
12. The method of any of embodiments 1 to 10, wherein the first node operates in a Fifth Generation, 5G, New Radio, NR, network.
13. The method of any of the previous embodiments, further comprising:
   obtaining user data; and
   forwarding the user data to a host computer or the wireless device.

### Group B Embodiments

14. A first node for Presence Reporting Area, PRA, state indication, the first node comprising:
   processing circuitry configured to perform any of the steps of any of the Group A embodiments; and
   power supply circuitry configured to supply power to the first node.
15. A communication system including a host computer comprising:
   processing circuitry configured to provide user data; and
   a communication interface configured to forward the user data to a cellular network for transmission to a User Equipment, UE;
   wherein the cellular network comprises a first node having a radio interface and processing circuitry, the first node's processing circuitry configured to perform any of the steps of any of the Group A embodiments.
16. The communication system of the previous embodiment further including the first node.
17. The communication system of the previous 2 embodiments, further including the UE, wherein the UE is configured to communicate with the first node.
18. The communication system of the previous 3 embodiments, wherein:
   the processing circuitry of the host computer is configured to execute a host application, thereby providing the user data; and
   the UE comprises processing circuitry configured to execute a client application associated with the host application.
19. A method implemented in a communication system including a host computer, a first node, and a User Equipment, UE, the method comprising:
   at the host computer, providing user data; and
   at the host computer, initiating a transmission carrying the user data to the UE via a cellular network comprising the first node, wherein the first node performs any of the steps of any of the Group A embodiments.
20. The method of the previous embodiment, further comprising, at the first node, transmitting the user data.
21. The method of the previous 2 embodiments, wherein the user data is provided at the host computer by executing a host application, the method further comprising, at the UE, executing a client application associated with the host application.
22. A User Equipment, UE, configured to communicate with a first node, the UE comprising a radio interface and processing circuitry configured to perform the method of the previous 3 embodiments.
23. A communication system including a host computer comprising a communication interface configured to receive user data originating from a transmission from a User Equipment, UE, to a first node, wherein the first node comprises a radio interface and processing circuitry, the first node's processing circuitry configured to perform any of the steps of any of the Group A embodiments.
24. The communication system of the previous embodiment further including the first node.
25. The communication system of the previous 2 embodiments, further including the UE, wherein the UE is configured to communicate with the first node.
26. The communication system of the previous 3 embodiments, wherein:
   the processing circuitry of the host computer is configured to execute a host application; and
   the UE is configured to execute a client application associated with the host application, thereby providing the user data to be received by the host computer.

At least some of the following abbreviations may be used in this disclosure. If there is an inconsistency between abbreviations, preference should be given to how it is used above. If listed multiple times below, the first listing should be preferred over any subsequent listing(s).

3GPP Third Generation Partnership Project

5G Fifth Generation

AF Application Function

AMF Authentication Management Function

APN Access Point Name

ASIC Application Specific Integrated Circuit

AUSF Authentication Server Function

AVP Attribute Value Pair

CCR Credit Control Request

CPU Central Processing Unit

DN Data Network

DSP Digital Signal Processor

eNB Evolved or Enhanced Node B

E-UTRAN Evolved Universal Terrestrial Radio Access Network

FPGA Field Programmable Gate Array

gNB New Radio Base Station

GPRS General Packet Radio Service

GW Gateway

IE Information Element

IP Internet Protocol

LTE Long Term Evolution

MME Mobility Management Entity

MTC Machine Type Communication

NEF Network Exposure Function

NR New Radio

NRF Network Repository Function

NSSF Network Slice Selection Function

OCS Online Charging System

OTT Over the Top

PCC Policy and Charging Control

PCRF/PCF Policy Control (Resource) Function

PDN Packet Data Network

PGW Packet Data Network Gateway

PRA Presence Reporting Area

PS Packet Switched

QoS Quality of Service

RAM Random Access Memory

RAN Radio Access Network

ROM Read Only Memory

RRH Remote Radio Head

RU Round Trip Time

SCEF Service Capability Exposure Function

SMF Session Management Function

TS Technical Specification

UDM Unified Data Management

UE User Equipment

Those skilled in the art will recognize improvements and modifications to the embodiments of the present disclosure. All such improvements and modifications are considered within the scope of the concepts disclosed herein.

1. A method performed by a first entity for reducing signaling for a Presence Reporting Area, PRA, state indication, the method comprising:
determining whether a wireless device is presumed to be in a PRA; and
indicating to a second entity whether the wireless device is presumed to be in the PRA.

2. The method of claim 1, wherein the first entity is a charging entity such as a Policy and Charging Rules Function, PCRF, or Policy Control Function, PCF.

3. The method of claim 1, wherein the second entity is a Packet Gateway, PGW, or a Session Management Function, SMF, or a combined SMF and control plane PGW, PGW-C.

4. The method of claim 1, wherein determining whether the wireless device is presumed to be in the PRA comprises determining that the wireless device is presumed to be in the PRA if the wireless device is more likely to be in the PRA.

5. The method of claim 1, wherein determining whether the wireless device is presumed to be in the PRA comprises determining whether the wireless device is presumed to be in the PRA based on a size of the PRA.

6. The method of claim 1, wherein the first entity is a Packet Gateway, PGW, the second entity is a Serving Gateway, SGW, and indicating to the second entity whether the wireless device is presumed to be in the PRA comprises sending a Create Session Response to the SGW indicating whether the wireless device is presumed to be in the PRA.

7. The method of claim 1, wherein the second entity is a Session Management Function, SMF, or a combined SMF and packet gateway, PGW, with control plane PGW, PGW-C, and the method further comprises the second entity providing to an Authentication Management Function, AMF, an indication whether the wireless device is presumed to be in the PRA.

8. The method of claim 1, wherein the first entity is a Serving Gateway, SGW, the second entity is a mobility entity such as a Mobility Management Entity, MME, and indicating to the second entity whether the wireless device is presumed to be in the PRA comprises sending a Create Session Response to the mobility entity indicating whether the wireless device is presumed to be in the PRA.

9. The method of claim 1, wherein indicating to the second entity whether the wireless device is presumed to be in the PRA comprises sending a PRA Action to the second entity that indicates whether the wireless device is presumed to be in the PRA.

10. The method of claim 9, wherein two bits in octet five of the PRA Action indicate whether the wireless device is presumed to be in the PRA.

11. The method of claim 10, wherein: a value of zero for the two bits indicates no presumption; a value of one for the two bits indicates the wireless device is presumed to be in the PRA; and a value of two for the two bits indicates the wireless device is presumed to be out of the PRA.

12. The method of claim 1, wherein the first entity operates in a Long Term Evolution, LTE, network, a Fifth Generation, 5G, network, or a New Radio, NR, network.

13. (canceled)

14. A first entity for reducing signaling for a Presence Reporting Area, PRA, state indication, the first entity comprising at least one processor and memory comprising instructions executable by the at least one processor whereby the first entity is operable to:
determine whether a wireless device is presumed to be in a PRA; and
indicate to a second entity whether the wireless device is presumed to be in the PRA.

15. The first entity of claim 14, wherein the first entity is a charging entity such as a Policy and Charging Rules Function, PCRF, or Policy Control Function, PCF.

16. The first entity of claim 14, wherein the second entity is a Packet Gateway, PGW, or a Session Management Function, SMF, or a combined SMF and control plane PGW, PGW-C.

17. The first entity of claim 14, wherein determining whether the wireless device is presumed to be in the PRA comprises being operable to determine that the wireless device is presumed to be in the PRA if the wireless device is more likely to be in the PRA.

18. The first entity of claim 14, wherein determining whether the wireless device is presumed to be in the PRA comprises being operable to determine whether the wireless device is presumed to be in the PRA based on a size of the PRA.

19. The first entity of claim 14, wherein the first entity is a Packet Gateway, PGW, the second entity is a Serving Gateway, SGW, and indicating to the second entity whether the wireless device is presumed to be in the PRA comprises being operable to send a Create Session Response to the SGW indicating whether the wireless device is presumed to be in the PRA.

20. The first entity of claim 14, wherein the second entity is a Session Management Function, SMF, or a combined SMF and packet gateway, PGW, with control plane PGW, PGW-C, and the second entity provides to an Authentication Management Function, AMF, an indication whether the wireless device is presumed to be in the PRA.

21. The method of claim 14, wherein the first entity is a Serving Gateway, SGW, the second entity is a mobility entity such as a Mobility Management Entity, MME, and indicating to the second entity whether the wireless device is presumed to be in the PRA comprises being operable to send a Create Session Response to the mobility entity indicating whether the wireless device is presumed to be in the PRA.

22. The first entity of claim 14, wherein indicating to the second entity whether the wireless device is presumed to be in the PRA comprises being operable to send a PRA Action to the second entity that indicates whether the wireless device is presumed to be in the PRA.

23. The first entity of claim 22, wherein two bits in octet five of the PRA Action indicate whether the wireless device is presumed to be in the PRA.

24. The first entity of claim 23, wherein: a value of zero for the two bits indicates no presumption; a value of one for the two bits indicates the wireless device is presumed to be in the PRA; and a value of two for the two bits indicates the wireless device is presumed to be out of the PRA.

25. The first entity of claim 14, wherein the first entity operates in a Long Term Evolution, LTE, network, a Fifth Generation, 5G, network, or a New Radio, NR, network.

26-28. (canceled)
